(19) United States
(12) Patent Application Publication
(10) Pub. No.: US 2026/0200047 A1
(43) Pub. Date: Jul. 16, 2026

(54) SOCKET ADAPTER DEVICE

(71) Applicant: GUOCHANG COLD FORGING CO., LTD., Taichung City (TW)

(72) Inventor: Ting-Wei CHU, Taichung City (TW)

(21) Appl. No.: 19/023,315

(22) Filed: Jan. 16, 2025

(51) Int. Cl. B25B 13/06

(52) U.S. Cl. CPC B25B 13/06

(57) ABSTRACT

A socket adapter device suitable for connecting a driver and two driven objects with different radial dimensions includes an outer sleeve, a sliding member inside the outer sleeve, and a switching member inserted into an accommodating groove of the sliding member and a guide groove of the outer sleeve. The switching member is driven to make the sliding member slide relative to the outer sleeve between a first and a second positions. When the sliding member is in the first position, one end of the sliding member allows the driver to be inserted thereinto, and one end of the outer sleeve allows one driven object to be inserted thereinto. When the sliding member is in the second position, the other end of the sliding member allows the driver to be inserted thereinto, and the other end of the outer sleeve allows the other driven object to be inserted thereinto.

### BACKGROUND

### Field of the Invention

The present invention relates to a socket, and more particularly to a socket adapter device, which can quickly switch its socketing mode to adapt to driven objects with different radial dimensions, such as, but not limited to, workpieces or parts.

### Description of Related Art

Many existing socket adapters that can adapt to workpieces of different sizes often adapt to workpieces of different sizes by replacing socket parts of different size specifications. However, the way of replacing socket parts is not efficient.

Moreover, most of these socket adapters use C-shaped snap rings to restrict the axial movement between the inner sleeve and the outer sleeve. If it is necessary to ensure that the inner sleeve or the outer sleeve can be easily pushed to generate the relative movement between the inner sleeve and the outer sleeve, the elasticity of the selected C-shaped snap ring should be small. However, the smaller the elasticity of the C-shaped snap ring is, the easier the C-shaped snap ring is to become detached due to excessive force when pushing the inner sleeve or the outer sleeve. On the contrary, the greater the elasticity of the C-shaped snap ring is, the greater the resistance in assembling the inner sleeve and the outer sleeve and the resistance encountered when pushing the inner sleeve or the outer sleeve will be, resulting in difficulties in assembly and inconvenience in use.

Related prior art includes patents TWI822256 and TW202339908.

### SUMMARY

To this end, the objective of the present invention is to provide a socket adapter device, which can overcome the problem that the prior art can only adapt to workpieces or parts with a single radial dimension, and by being able to adapt to workpieces or parts with different radial dimensions, the present invention can reduce the number of adapters or extension devices that users need to carry.

Another objective of the present invention is to provide a socket adapter device. By means of a switching mechanism, users can simply and quickly switch the socketing mode of the socket adapter device to socket workpieces or parts with different radial dimensions.

To achieve the above objective, a socket adapter device provided in accordance with one embodiment of the present invention is suitable for connecting a driver and two driven objects with different radial dimensions, and includes: an outer sleeve, including a sleeve body, a sliding channel formed by the sleeve body, and a guide groove penetrating through the sleeve body, wherein radial dimensions of a first force output port and a second force output port on two opposite sides of the sliding channel are different; a sliding member, slidably disposed in the sliding channel, and including a first force input groove located at a first end thereof, a second force input groove located at a second end thereof, and an accommodating groove located between the first end and the second end, the first end being opposite to the second end; and a switching member, disposed in the accommodating groove and inserted into the guide groove, wherein the switching member is used to be driven by a user to slide along the guide groove so as to drive the sliding member to slide between a first position and a second position relative to the outer sleeve; wherein, when the sliding member is in the first position, the first force input groove of the sliding member allows the driver to be inserted, and the second force output port of the outer sleeve allows one of the driven objects to be inserted; and when the sliding member is in the second position, the second force input groove of the sliding member allows the driver to be inserted, and the first force output port of the outer sleeve allows the other driven object to be inserted.

Optionally, the guide groove includes a guide hole and two positioning holes located on two opposite sides of the guide hole and communicating with the guide hole; when the sliding member is in the first position, the switching member is aligned with one of the positioning holes; and when the sliding member is in the second position, the switching member is aligned with the other positioning hole.

Optionally, the socket adapter device further includes: a spring disposed in the accommodating groove with two opposite ends respectively pushing against a groove bottom surface of the accommodating groove and the switching member; wherein, when the switching member is pressed, the spring is compressed by the switching member to accumulate a restoring force, and the switching member leaves an inner wall surface of the outer sleeve to allow the sliding member to slide relative to the outer sleeve; and when the switching member is released, the restoring force drives the switching member to tightly abut against the inner wall surface of the outer sleeve to prevent the sliding member from sliding relative to the outer sleeve.

Optionally, the switching member includes a pushing portion movably disposed in the accommodating groove, a limiting portion connected to the pushing portion and detachably disposed in the guide groove, and a contact portion connected to the limiting portion, protruding from the sleeve body and used for being driven by a user, the limiting portion is located between the pushing portion and the contact portion, and the two opposite ends of the spring respectively push against the groove bottom surface of the accommodating groove and the pushing portion; when the switching member is pressed, the contact portion enters the guide groove, the limiting portion leaves the guide groove, and the pushing portion leaves the inner wall surface of the outer sleeve and compresses the spring; and when the switching member is released, the spring pushes against the pushing portion to make the pushing portion tightly abut against the inner wall surface of the outer sleeve, the limiting portion returns to the guide groove, and the contact portion leaves the guide groove.

Optionally, the guide hole extends along a central axis of the socket adapter device, and diameters of the two positioning holes are larger than a width of the guide hole in an axial direction perpendicular to the central axis.

Optionally, at least one of the pushing portion, the limiting portion and the contact portion of the switching member is provided with a chamfer at a position where it contacts the sleeve body.

Optionally, an outer annular surface of the sliding member is provided with a protrusion at the first end of the sliding member, and an inner wall surface of the outer sleeve is provided with an annular groove at the first end of the outer sleeve to form the first force output port, and a groove bottom surface of the annular groove is used to allow the protrusion of the sliding member to be detachably abutted so as to limit a stroke length of the sliding member sliding relative to the outer sleeve.

Optionally, the pushing portion is provided with a groove at one end close to the spring for accommodating the spring, and two opposite ends of the spring respectively abut against the bottom surface of the accommodating groove and a bottom surface of the groove of the pushing portion.

A socket adapter device provided in accordance with an embodiment of the present invention is suitable for connecting a driver and two driven objects with different radial dimensions, and includes: an outer sleeve, including a sleeve body, a sliding channel formed by the sleeve body, and two positioning holes penetrating through the sleeve body, wherein radial dimensions of a first force output port and a second force output port on two opposite sides of the sliding channel are different; a sliding member, slidably disposed in the sliding channel and having a first position and a second position relative to the outer sleeve, the sliding member including a first force input groove located at a first end thereof, a second force input groove located at a second end thereof, and an accommodating groove located between the first end and the second end, wherein the first end is opposite to the second end; a switching member, movably disposed in the accommodating groove and detachably and selectively inserted into one of the positioning holes; and a spring, disposed in the accommodating groove, with two opposite ends respectively pushing against a groove bottom surface of the accommodating groove and the switching member; wherein, when the switching member is pressed, the spring is compressed by the switching member to accumulate a restoring force, and the switching member leaves one of the positioning holes to allow the sliding member to slide relative to the outer sleeve; when the sliding member is in the first position, the first force input groove of the sliding member allows the driver to be inserted, the second force output port of the outer sleeve allows one of the driven objects to be inserted, and the switching member is aligned with one of the positioning holes; when the sliding member is in the second position, the second force input groove of the sliding member allows the driver to be inserted, the first force output port of the outer sleeve allows the other driven object to be inserted, and the switching member is aligned with the other positioning hole; and when the switching member is aligned with either of the two positioning holes, the restoring force drives the switching member to be inserted into the aligned positioning hole to prevent the sliding member from sliding relative to the outer sleeve.

Optionally, the switching member includes a pushing portion movably disposed in the accommodating groove, a limiting portion connected to the pushing portion and detachably disposed in the guide groove, and a contact portion connected to the limiting portion, protruding from the sleeve body and used for being driven by a user, wherein the limiting portion is located between the pushing portion and the contact portion, and two opposite ends of the spring respectively push against a groove bottom surface of the accommodating groove and the pushing portion; when the switching member is pressed, the contact portion disengages from one of the positioning holes and enters an accommodating groove of the sliding member, and the pushing portion leaves an inner wall surface of the outer sleeve and compresses the spring; and when the contact portion is in the accommodating groove, and the sliding member slides relative to the outer sleeve, the contact portion contacts the inner wall surface of the outer sleeve until the switching member is aligned with the other positioning hole.

Optionally, at least one of the pushing portion, the limiting portion and the contact portion of the switching member is provided with a chamfer at a position where it contacts the sleeve body.

Optionally, an outer annular surface of the sliding member is provided with a protrusion at the first end of the sliding member, and an inner wall surface of the outer sleeve is provided with an annular groove at the first end of the outer sleeve to form the first force output port, and a groove bottom surface of the annular groove is used to allow the protrusion of the sliding member to be detachably abutted so as to limit a stroke length of the sliding member sliding relative to the outer sleeve.

Optionally, the pushing portion is provided with a groove at one end close to the spring for accommodating the spring, and two opposite ends of the spring respectively abut against the bottom surface of the accommodating groove and a bottom surface of the groove of the pushing portion.

### BRIEF DESCRIPTION OF THE DRAWINGS

Other aspects and advantages of the present invention will be found after studying the detailed description in conjunction with the following accompanying drawings:

FIG. 1 is an exploded schematic view of a socket adapter device according to an embodiment of the present invention;

FIG. 2 is a schematic external view of a socket adapter device according to an embodiment of the present invention;

FIG. 3 is a cross-sectional view of the socket adapter device of FIG. 2, showing the state of the socket adapter device when the switching member is tightly pressed against the inner wall surface of the outer sleeve;

FIG. 4 is a cross-sectional view of the socket adapter device of FIG. 2, showing the state of the socket adapter device when the sliding member is in the first position;

FIG. 5 is a schematic view of the socket adapter device of FIG. 4 in use, showing the state of the socket adapter device when the switching member is pressed;

FIG. 6 is a schematic view of the socket adapter device of FIG. 4 in use, showing the state of the socket adapter device when the switching member drives the sliding member to move to the second position and is then released;

FIG. 7 is a schematic view of the socket adapter device of FIG. 4 when connecting a driver and a driven object with a smaller radial dimension;

FIG. 8 is a schematic view of the socket adapter device of FIG. 6 when connecting a driver and a driven object with a larger radial dimension;

FIG. 9 is a schematic external view of a socket adapter device according to an embodiment of the present invention;

FIG. 10 is a cross-sectional view of the socket adapter device of FIG. 9, showing the state of the socket adapter device when the switching member is tightly pressed against the inner wall surface of the outer sleeve;

FIG. 11 is a cross-sectional view of the socket adapter device of FIG. 9, showing the state of the socket adapter device when the sliding member is in the first position; and

FIG. 12 is a schematic view of the socket adapter device of FIG. 11 in use, showing the state of the socket adapter device when the sliding member is pushed so that the switching member slides against the inner wall surface of the outer sleeve.

### DETAILED DESCRIPTION

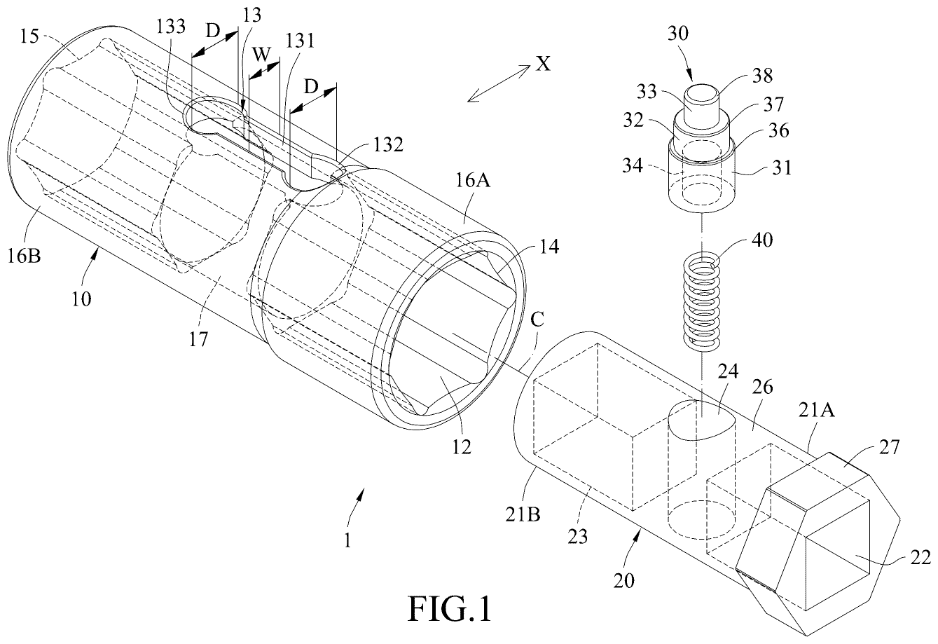

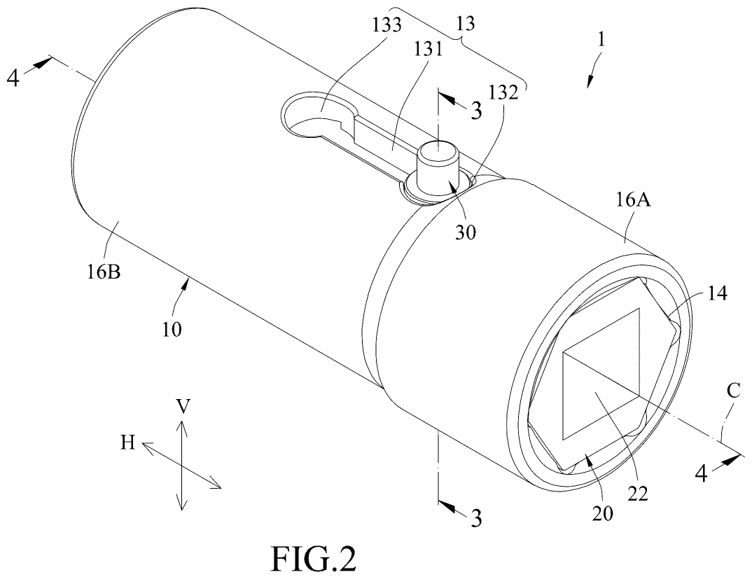

Please refer to FIGS. 1 to 8, a socket adapter device 1 provided according to an embodiment of the present invention is suitable for connecting a driver DR and driven objects ND1 and ND2 with different radial dimensions. The type of the driver DR is, for example but not limited to, devices that can provide an input rotational force, such as manual tools, pneumatic tools or electric tools. The driven objects ND1 and ND2 are, for example but not limited to, workpieces, parts or hand tools. The types of the driven objects ND1 and ND2 are, for example but not limited to, nuts, socket screwdriver heads, screwdriver heads and so on.

The socket adapter device 1 includes an outer sleeve 10, a sliding member 20 and a switching member 30.

The outer sleeve 10 includes a sleeve body 11, a sliding channel 12 formed by the sleeve body 11 and a guide groove 13 penetrating through the sleeve body 11. The sliding channel 12 has a first force output port 14 and a second force output port 15 on two opposite end surfaces of the outer sleeve 10 respectively, and the first force output port 14 and the second force output port 15 have different radial dimensions. In this embodiment, the radial dimension of the first force output port 14 is larger than that of the second force output port 15. Therefore, the driven object ND1 with a larger radial dimension can be inserted into the first force output port 14, and the driven object ND2 with a smaller radial dimension can be inserted into the second force output port 15.

The sliding member 20 is slidably disposed in the sliding channel 12 of the outer sleeve 10 and includes a first force input groove 22 located at a first end 21A thereof, a second force input groove 23 located at a second end 21B thereof and an accommodating groove 24 located between the first end 21A and the second end 21B. The first end 21A is opposite to the second end 21B. The radial dimension of the first force input groove 22 is the same as that of the second force input groove 23, and the opening shape of the first force input groove 22 is also the same as that of the second force input groove 23. In this embodiment, the opening shapes of the first force input groove 22 and the second force input groove 23 are both rectangular. The driver DR can be inserted into the first force input groove 22 or the second force input groove 23 as required.

The switching member 30 is movably disposed in the accommodating groove 24 of the sliding member 20 and detachably inserted into the guide groove 13 of the outer sleeve 10. The switching member 30 can be driven to move relative to the sleeve body 11 of the outer sleeve 10 between an unlocked position and a locked position in a vertical direction V. The switching member 30 can also be driven to slide along the guide groove 13 in a horizontal direction H so as to drive the sliding member 20 to slide relative to the outer sleeve 10 between a first position and a second position.

The following is an exemplary description of the method of using the socket adapter device 1 of the present invention.

### Switching to a Socket Mode Adaptable to the Driven Object With a Larger Radial Dimension

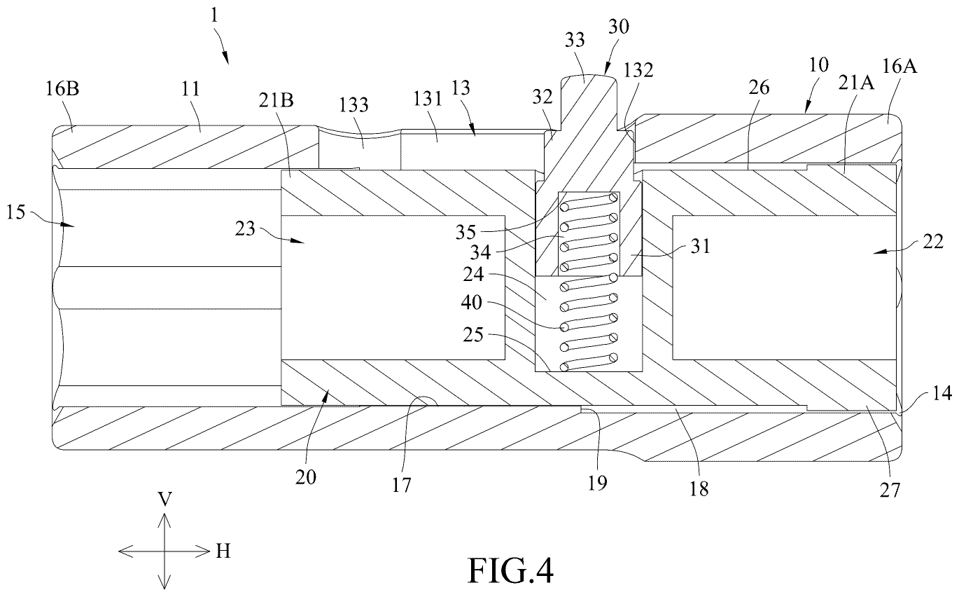

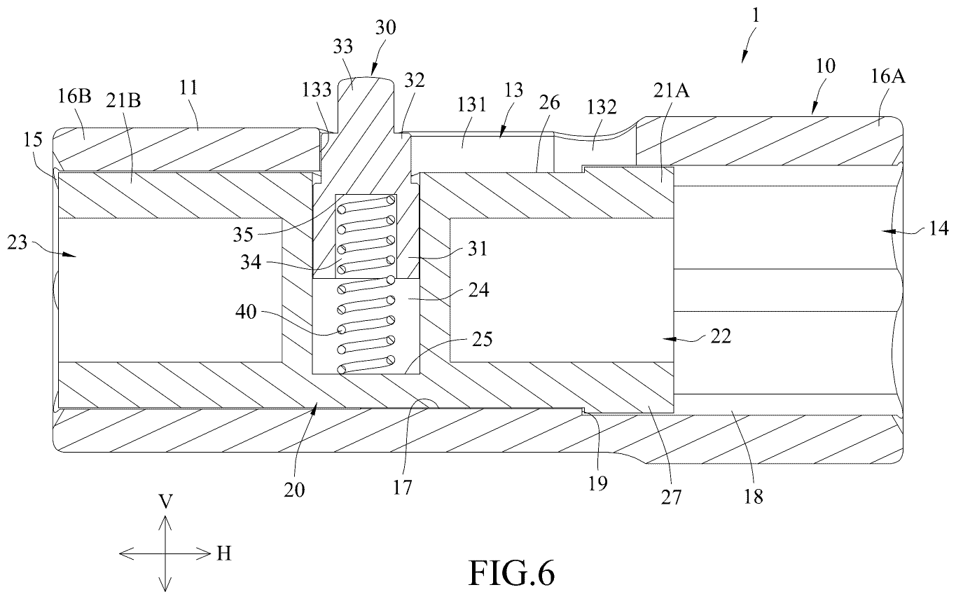

When it is desired to switch from the socket mode adaptable to the driven object with a smaller radial dimension to the socket mode adaptable to the driven object with a larger radial dimension, the user can manually push the switching member 30 to make it move along the guide groove 13 starting from the end point of the guide groove 13 on a first end 16A of the outer sleeve 10, so as to drive the sliding member 20 to slide in the horizontal direction H relative to the outer sleeve 10 from the first position (as shown in FIG. 4) to the second position (as shown in FIG. 6).

When the switching member 30 reaches the end point of the guide groove 13 on a second end 16B (opposite to the first end 16A) of the outer sleeve 10, the user can release the switching member 30. At this time, the sliding member 20 reaches the second position as shown in FIG. 6, and the second end 21B of the sliding member 20 occupies the second end 16B of the outer sleeve 10, while the first end 21A of the sliding member 20 is released from the first end 16A of the outer sleeve 10, as shown in FIG. 6.

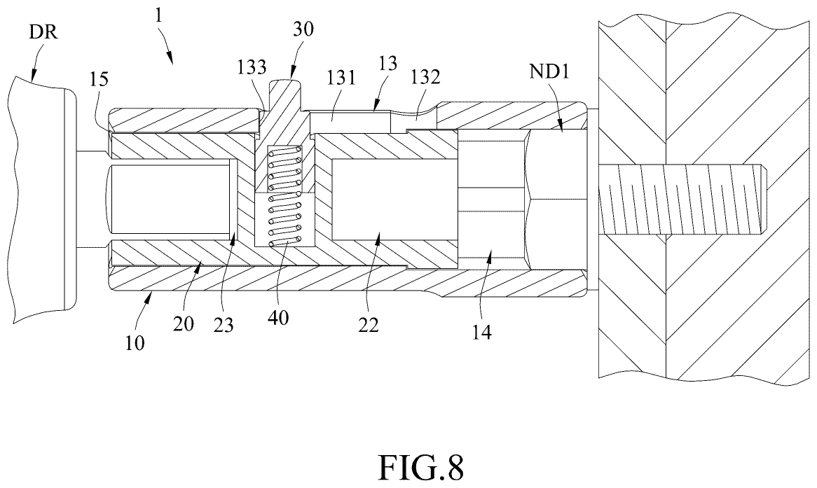

In this way, as shown in FIG. 8, the driver DR can be inserted in the second force input groove 23 of the sliding member 20, and the driven object with a larger radial dimension can be inserted in the first force output port 14 of the outer sleeve 10.

### Switching to a Socket Mode Adaptable to the Driven Object With a Larger Radial Dimension

When it is desired to switch from the socket mode adaptable to the driven object with a larger radial dimension to the socket mode adaptable to the driven object with a smaller radial dimension, the user can manually push the switching member 30 to make it move along the guide groove 13 starting from the end point of the guide groove 13 on the second end 16B of the outer sleeve 10, so as to drive the sliding member 20 to slide in the horizontal direction H relative to the outer sleeve 10 from the second position (as shown in FIG. 6) to the first position (as shown in FIG. 4).

When the switching member 30 reaches the end point of the guide groove 13 on the first end 16A of the outer sleeve 10, the user can release the switching member 30. At this time, the sliding member 20 reaches the first position, and the first end 21A of the sliding member 20 occupies the first end 16A of the outer sleeve 10, while the second end 21B of the sliding member 20 is released from the second end 16B of the outer sleeve 10, as shown in FIG. 4.

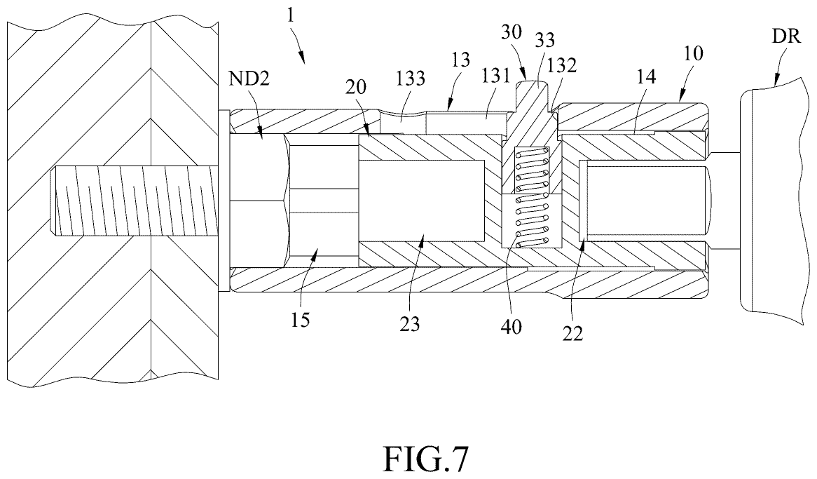

In this way, as shown in FIG. 7, the driver DR can be inserted in the first force input groove 22 of the sliding member 20, and the driven object with a smaller radial dimension can be inserted in the second force output port 15 of the outer sleeve 10.

In this embodiment or other embodiments, the guide groove 13 of the outer sleeve 10 can optionally include a guide hole 131 extending along a central axis C of the socket adapter device 1 and two positioning holes 132 and 133 located on opposite sides of the guide hole 131 and communicating with the guide hole 131. The positioning hole 132 is the end point of the guide groove 13 at the first end 16A of the outer sleeve 10, and the positioning hole 133 is the end point of the guide groove 13 at the second end 16B of the outer sleeve 10. When the sliding member 20 is in the first position, the switching member 30 is aligned with the positioning hole 132, as shown in FIG. 4; and when the sliding member 20 is in the second position, the switching member 30 is aligned with the positioning hole 133, as shown in FIG. 6.

In this embodiment or other embodiments, the hole diameters D of the two positioning holes 132 and 133 of the guide groove 13 of the outer sleeve 10 can optionally be the same and can optionally be larger than the width W of the guide hole 131 in an axial direction X perpendicular to the central axis C of the socket adapter device 1, as shown in FIG. 1.

In this embodiment or other embodiments, the guide groove 13 of the outer sleeve 10 can also optionally be changed so that the hole diameters D of the two positioning holes 132 and 133 are the same as the width W of the guide hole 131 in the axial direction X.

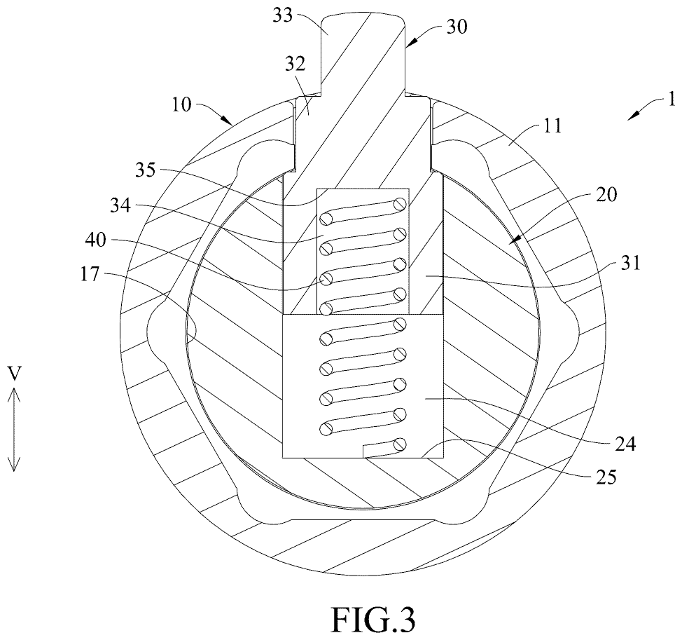

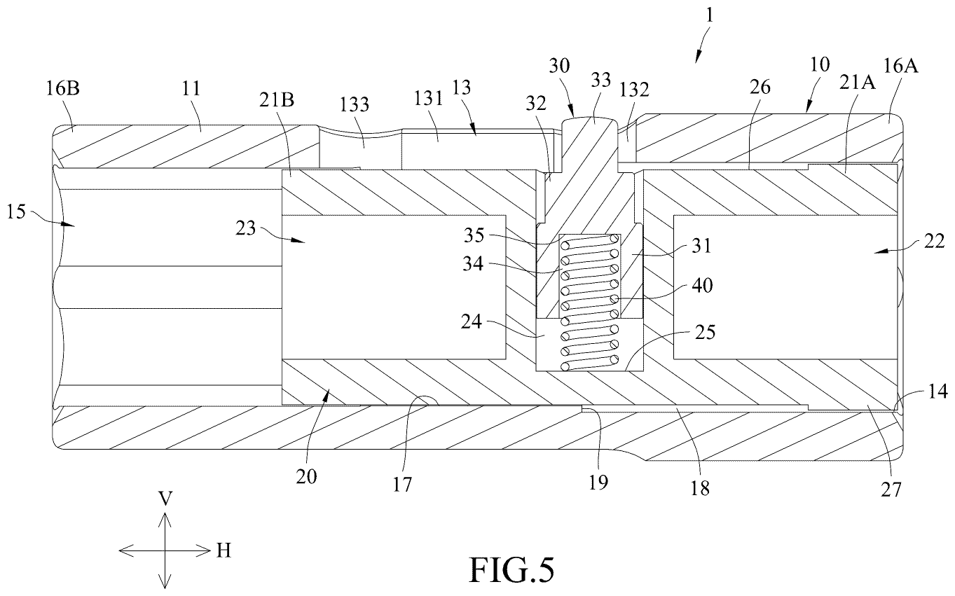

In this embodiment or other embodiments, the socket adapter device 1 can optionally further include a spring 40, which is disposed in the accommodating groove 24 of the sliding member 20. The opposite ends of the spring 40 respectively push against a groove bottom surface 25 of the accommodating groove 24 and the switching member 30. Therefore, the switching member 30 can move relative to the sleeve body 11 of the outer sleeve 10 between an unlocked position (as shown in FIG. 5) and a locked position (as shown in FIG. 3) in the vertical direction V. When the switching member 30 is pressed to the unlocked position as shown in FIG. 5, the spring 40 is compressed by the switching member 30 to accumulate a restoring force, and the switching member 30 leaves an inner wall surface 17 of the outer sleeve 10 to allow the sliding member 20 to slide relative to the outer sleeve 10. When the switching member 30 is aligned with one of the end points (i.e., the positioning hole 132 or 133) of the guide groove 13 and is released, the restoring force on the spring 40 will drive the switching member 30 back to the locked position (as shown in FIG. 4 or FIG. 6), so that the switching member 30 tightly abuts against the inner wall surface 17 of the outer sleeve 10 (as shown in FIG. 3) to stop the sliding member 20 from sliding relative to the outer sleeve 10.

In this embodiment or other embodiments, the socket adapter device 1 can also optionally omit the spring 40 for pushing the switching member 30, so that when the switching member 30 does not tightly abut against the inner wall surface 17 of the outer sleeve 10, the user can directly push the switching member 30 to the first position or the second position as required.

In this embodiment or other embodiments, the switching member 30 can optionally include a pushing portion 31 movably disposed in (or inserted into) the accommodating groove 24 of the sliding member 20, a limiting portion 32 connected to the pushing portion 31 and detachably disposed in (or inserted into) the guide groove 13, and a contact portion 33 connected to the limiting portion 32, protruding from the sleeve body 11 of the outer sleeve 10 and used for being driven by the user. The limiting portion 32 is located between the pushing portion 31 and the contact portion 33. The opposite ends of the spring 40 respectively push against the groove bottom surface 25 of the accommodating groove 24 and the pushing portion 31. When the switching member 30 is in the unlocked position, the contact portion 33 enters the guide groove 13, the limiting portion 32 leaves the guide groove 13, the pushing portion 31 leaves the inner wall surface 17 of the outer sleeve 10 and compresses the spring 40. When the switching member 30 is in the locked position, the spring 40 pushes against the pushing portion 31, the pushing portion 31 tightly abuts against the inner wall surface 17 of the outer sleeve 10, the limiting portion 32 returns to the guide groove 13, and the contact portion 33 leaves the guide groove 13.

In this embodiment or other embodiments, the pushing portion 31 of the switching member 30 can optionally be provided with a groove 34 at one end close to the spring 40 for accommodating the spring 40. The opposite ends of the spring 40 respectively abut against the groove bottom surface 25 of the accommodating groove 24 of the sliding member 20 and a groove bottom surface 35 of the groove 34 of the pushing portion 31 of the switching member 30.

In this embodiment or other embodiments, the pushing portion 31 of the switching member 30 can optionally be provided with a chamfer 36 at the position where it contacts the sleeve body 11 of the outer sleeve 10.

In this embodiment or other embodiments, the limiting portion 32 of the switching member 30 can optionally be provided with a chamfer 37 at the position where it contacts the sleeve body 11 of the outer sleeve 10.

In this embodiment or other embodiments, the contact portion 33 of the switching member 30 can optionally be provided with a chamfer 38 at the position where it contacts the sleeve body 11 of the outer sleeve 10.

In this embodiment or other embodiments, an outer annular surface 26 of the sliding member 20 can optionally be provided with a protrusion 27 at the first end 21A of the sliding member 20, and the inner wall surface 17 of the outer sleeve 10 can optionally be provided with an annular groove 18 at the first end 16A of the outer sleeve 10 for forming the first force output port 14. A groove bottom surface 19 of the annular groove 18 of the outer sleeve 10 allows the protrusion 27 of the sliding member 20 to be detachably abutted so as to limit the stroke length of the sliding member 20 sliding relative to the outer sleeve 10.

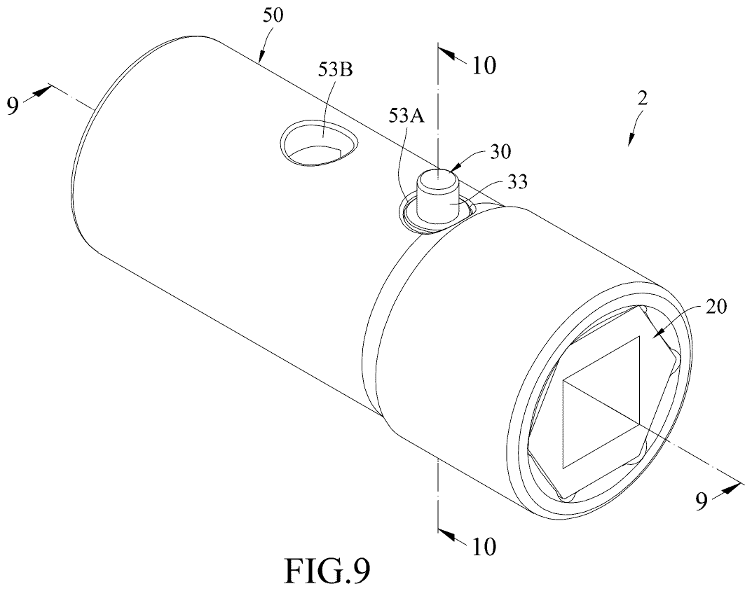

In addition, please refer to FIGS. 9 to 12, the present invention also provides another socket adapter device 2 according to an embodiment, which is substantially similar to the socket adapter device 1 in FIGS. 1 to 8 and includes an outer sleeve 50, a sliding member 20, a switching member 30 and a spring 40.

Specifically, the sliding member 20, the switching member 30 and the spring 40 in FIGS. 9 to 12 are the same as those in FIGS. 1 to 8. The outer sleeve 50 in FIGS. 9 to 12 is similar to the outer sleeve 10 in FIGS. 1 to 8, except that the sleeve body 51 of the outer sleeve 50 in FIGS. 9 to 12 is changed to be provided with positioning holes 53A and 53B penetrating through the sleeve body 51, and the guide hole is omitted.

Correspondingly, the usage method of the socket adapter device 2 in FIGS. 9 to 12 is also slightly different from that of the socket adapter device 1 in FIGS. 1 to 8, and is exemplarily described as follows.

### Switching to the Socket Mode Adaptable to the Driven Object With a Larger Radial Dimension

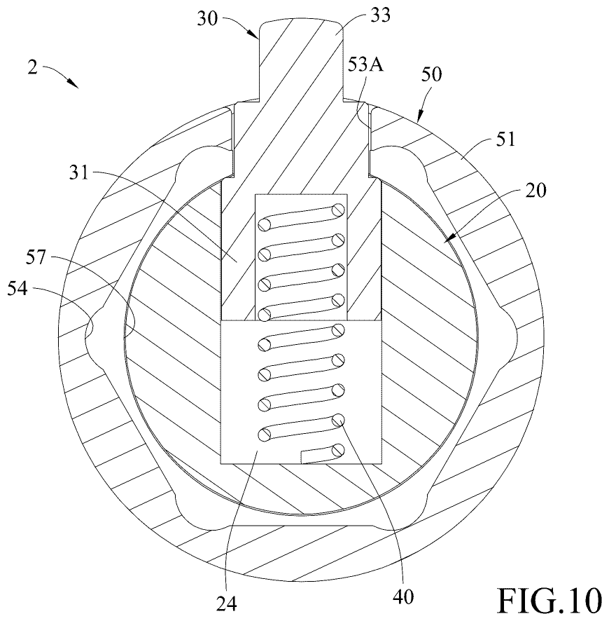

When it is desired to switch from the socket mode adaptable to the driven object with a smaller radial dimension to the socket mode adaptable to the driven object with a larger radial dimension, the user can first manually press the switching member 30 to make the switching member 30 move downward from the locked position (as shown in FIG. 10) to the unlocked position. When the switching member 30 reaches the unlocked position, the switching member 30 leaves the positioning hole 53A; specifically, the contact portion 33 of the switching member 30 disengages from the positioning hole 53A of the outer sleeve 50 and enters the accommodating groove 24 of the sliding member 20, and the pushing portion 31 of the switching member 30 leaves the inner wall surface 57 of the outer sleeve 50 and compresses the spring 40, so that the spring 40 accumulates a restoring force. Thereby, the sliding member 20 is allowed to slide relative to the outer sleeve 50.

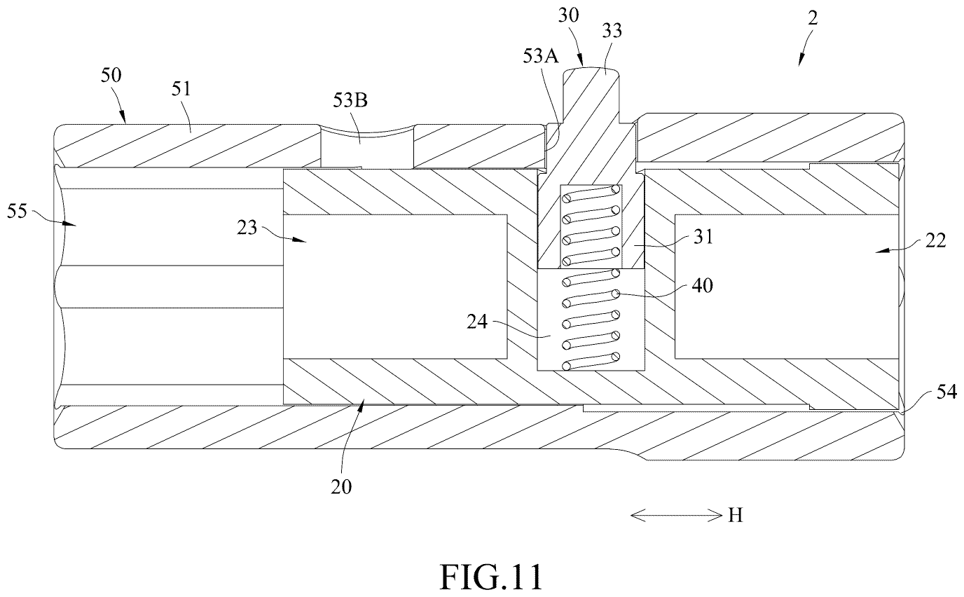

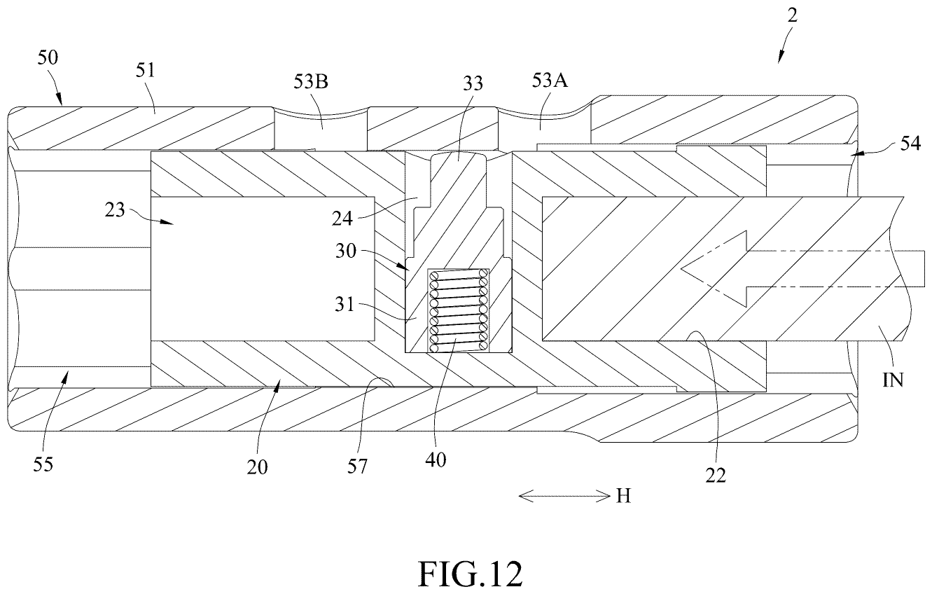

Then, the user can push the outer sleeve 50 or the sliding member 20 to make the sliding member 20 slide from the first position (as shown in FIG. 11) to the second position relative to the outer sleeve 50 in the horizontal direction H, as shown in FIG. 12. At this time, the contact portion 33 of the switching member 30 will contact the inner wall surface 57 of the outer sleeve 50. The method of pushing the outer sleeve 50 is, for example, but not limited to, first using the insert IN (a driving object, a driven object, or a finger) that has been inserted into the sliding member 20 to keep the sliding member 20 fixed, and then pushing the outer sleeve 50 by hand to move the outer sleeve 50 relative to the sliding member 20. The method for the user to push the sliding member 20 is, for example, but not limited to, first gripping the outer sleeve 50 with the hand to keep it fixed, and then, by pushing the insert IN that has been inserted into the sliding member 20, making the sliding member 20 move relative to the fixed outer sleeve 50.

When the sliding member 20 reaches the second position, the switching member 30 will be aligned with the positioning hole 53B, and the restoring force on the spring 40 will automatically drive the switching member 30 to be inserted into the aligned positioning hole 53B; specifically, the spring 40 will push upward the pushing portion 31 of the switching member 30, so that the contact portion 33 of the switching member 30 can be automatically inserted into the aligned positioning hole 53B until the pushing portion 31 of the switching member 30 tightly abuts against the inner wall surface 57 of the outer sleeve 50, so that the switching member 30 returns to the locked position. Thereby, the sliding of the sliding member 20 relative to the outer sleeve 50 can be prevented.

In this way, the driver can be inserted into the second force input groove 23 of the sliding member 20, and the driven object with a larger radial dimension can be inserted into the first force output port 54 of the outer sleeve 50.

### Switching to the Socket Mode Adaptable to the Driven Object With a Smaller Radial Dimension

When it is desired to switch from the socket mode adaptable to the driven object with a larger radial dimension to the socket mode adaptable to the driven object with a smaller radial dimension, the user can first manually press the switching member 30 to make it move downward from the locked position to the unlocked position. When the switching member 30 reaches the unlocked position, the contact portion 33 of the switching member 30 disengages from the positioning hole of the outer sleeve 50 and enters the accommodating groove 24 of the sliding member 20, and the pushing portion 31 of the switching member 30 leaves the inner wall surface 57 of the outer sleeve 50 and compresses the spring 40, so that the spring 40 accumulates a restoring force. Thereby, the sliding member 20 is allowed to slide relative to the outer sleeve 50.

Then, the user can push the outer sleeve 50 or the sliding member 20 to make the sliding member 20 slide in the horizontal direction H relative to the outer sleeve 50 from the second position to the first position (as shown in FIG. 11).

When the sliding member 20 reaches the first position, the switching member 30 will be aligned with the positioning hole 53A, and the restoring force on the spring 40 will push the pushing portion 31 of the switching member 30 upward, so the contact portion 33 of the switching member 30 can be automatically inserted into the aligned positioning hole 53A until the pushing portion 31 of the switching member 30 tightly abuts against the inner wall surface 17 of the outer sleeve 50. In this way, the switching member 30 returns to the locked position, as shown in FIG. 10. Thereby, the sliding of the sliding member 20 relative to the outer sleeve 50 can be prevented.

In this way, the driver can be inserted into the first force input groove 22 of the sliding member 20, and the driven object with a smaller radial dimension can be inserted into the second force output port 55 of the outer sleeve 50.

In summary, by being provided with a switching mechanism (i.e., the switching member and the guide groove (or a plurality of guide holes)) that can be driven by the user, the present invention enables the user to switch the socket mode of the socket adapter device simply and quickly to adapt to driven objects with different radial dimensions. The present invention also enables the switching member to move smoothly within the guide groove by designing the switching member in a cylindrical shape. In addition, by providing a chamfer on the part of the switching member that will contact the sleeve body of the outer sleeve, the present invention enables the switching member to enter the outer sleeve smoothly when moving relative to the sleeve body in the vertical direction.

Although the present invention has been disclosed above with the foregoing embodiments, these embodiments are not intended to limit the present invention. Any changes, modifications, and combinations of various implementation aspects within the spirit and scope of the present invention fall within the patent protection scope of the present invention. For the protection scope defined by the present invention, please refer to the attached claims.

What is claimed is:

1. A socket adapter device, suitable for connecting a driver and two driven objects with different radial dimensions, and comprising:
an outer sleeve, including a sleeve body, a sliding channel formed by the sleeve body, and a guide groove penetrating through the sleeve body, wherein radial dimensions of a first force output port and a second force output port on two opposite sides of the sliding channel are different;
a sliding member, slidably disposed in the sliding channel, and including a first force input groove located at a first end thereof, a second force input groove located at a second end thereof, and an accommodating groove located between the first end and the second end, and the first end being opposite to the second end; and
a switching member, disposed in the accommodating groove and inserted into the guide groove, wherein the switching member is used to be driven by a user to slide along the guide groove so as to drive the sliding member to slide between a first position and a second position relative to the outer sleeve;
wherein, when the sliding member is in the first position, the first force input groove of the sliding member allows the driver to be inserted thereinto, and the second force output port of the outer sleeve allows one of the driven objects to be inserted thereinto; and
when the sliding member is in the second position, the second force input groove of the sliding member allows the driver to be inserted thereinto, and the first force output port of the outer sleeve allows the other driven object to be inserted thereinto.

2. The socket adapter device as claimed in claim 1, wherein the guide groove includes a guide hole and two positioning holes located on two opposite sides of the guide hole and communicating with the guide hole;
when the sliding member is in the first position, the switching member is aligned with one of the positioning holes; and
when the sliding member is in the second position, the switching member is aligned with the other one of the positioning holes.

3. The socket adapter device as claimed in claim 2, further comprising:
a spring disposed in the accommodating groove with two opposite ends respectively pushing against a groove bottom surface of the accommodating groove and the switching member;
wherein, when the switching member is pressed, the spring is compressed by the switching member to accumulate a restoring force, and the switching member leaves an inner wall surface of the outer sleeve to allow the sliding member to slide relative to the outer sleeve; and
when the switching member is released, the restoring force drives the switching member to tightly abut against the inner wall surface of the outer sleeve to prevent the sliding member from sliding relative to the outer sleeve.

4. The socket adapter device as claimed in claim 3, wherein the switching member includes a pushing portion movably disposed in the accommodating groove, a limiting portion connected to the pushing portion and detachably disposed in the guide groove, and a contact portion connected to the limiting portion, protruding from the sleeve body and used for being driven by a user, the limiting portion is located between the pushing portion and the contact portion, and the two opposite ends of the spring respectively push against the groove bottom surface of the accommodating groove and the pushing portion;
when the switching member is pressed, the contact portion enters the guide groove, the limiting portion leaves the guide groove, and the pushing portion leaves the inner wall surface of the outer sleeve and compresses the spring; and
when the switching member is released, the spring pushes against the pushing portion to make the pushing portion tightly abut against the inner wall surface of the outer sleeve, the limiting portion returns to the guide groove, and the contact portion leaves the guide groove.

5. The socket adapter device as claimed in claim 2, wherein the guide hole extends along a central axis of the socket adapter device, and diameters of the two positioning holes are larger than a width of the guide hole in an axial direction perpendicular to the central axis.

6. A socket adapter device, suitable for connecting a driver and two driven objects with different radial dimensions, and comprising:
an outer sleeve, including a sleeve body, a sliding channel formed by the sleeve body, and two positioning holes penetrating through the sleeve body, wherein radial dimensions of a first force output port and a second force output port on two opposite sides of the sliding channel are different;
a sliding member, slidably disposed in the sliding channel and having a first position and a second position relative to the outer sleeve, the sliding member including a first force input groove located at a first end thereof, a second force input groove located at a second end thereof, and an accommodating groove located between the first end and the second end, wherein the first end is opposite to the second end;
a switching member, movably disposed in the accommodating groove and detachably and selectively inserted into one of the positioning holes; and
a spring, disposed in the accommodating groove, with two opposite ends respectively pushing against a groove bottom surface of the accommodating groove and the switching member;
wherein, when the switching member is pressed, the spring is compressed by the switching member to accumulate a restoring force, and the switching member leaves one of the positioning holes to allow the sliding member to slide relative to the outer sleeve;
when the sliding member is in the first position, the first force input groove of the sliding member allows the driver to be inserted thereinto, the second force output port of the outer sleeve allows one of the driven objects to be inserted thereinto, and the switching member is aligned with one of the positioning holes;
when the sliding member is in the second position, the second force input groove of the sliding member allows the driver to be inserted thereinto, the first force output port of the outer sleeve allows the other driven object to be inserted thereinto, and the switching member is aligned with the other positioning hole; and
when the switching member is aligned with either of the two positioning holes, the restoring force drives the switching member to be inserted into the aligned positioning hole to prevent the sliding member from sliding relative to the outer sleeve.

7. The socket adapter device as claimed in claim 6, wherein the switching member includes a pushing portion movably disposed in the accommodating groove, a limiting portion connected to the pushing portion and detachably disposed in the guide groove, and a contact portion connected to the limiting portion, protruding from the sleeve body and used for being driven by a user, wherein the limiting portion is located between the pushing portion and the contact portion, and two opposite ends of the spring respectively push against a groove bottom surface of the accommodating groove and the pushing portion;
when the switching member is pressed, the contact portion disengages from one of the positioning holes and enters an accommodating groove of the sliding member, and the pushing portion leaves an inner wall surface of the outer sleeve and compresses the spring; and
when the contact portion is in the accommodating groove, and the sliding member slides relative to the outer sleeve, the contact portion contacts the inner wall surface of the outer sleeve until the switching member is aligned with the other positioning hole.

8. The socket adapter device as claimed in claim 4, wherein at least one of the pushing portion, the limiting portion and the contact portion of the switching member is provided with a chamfer at a position where it contacts the sleeve body.

9. The socket adapter device as claimed in claim 7, wherein at least one of the pushing portion, the limiting portion and the contact portion of the switching member is provided with a chamfer at a position where it contacts the sleeve body.

10. The socket adapter device as claimed in claim 1, wherein an outer annular surface of the sliding member is provided with a protrusion at the first end of the sliding member, and an inner wall surface of the outer sleeve is provided with an annular groove at the first end of the outer sleeve to form the first force output port, and a groove bottom surface of the annular groove is used to allow the protrusion of the sliding member to be detachably abutted so as to limit a stroke length of the sliding member sliding relative to the outer sleeve.

11. The socket adapter device as claimed in claim 6, wherein an outer annular surface of the sliding member is provided with a protrusion at the first end of the sliding member, and an inner wall surface of the outer sleeve is provided with an annular groove at the first end of the outer sleeve to form the first force output port, and a groove bottom surface of the annular groove is used to allow the protrusion of the sliding member to be detachably abutted so as to limit a stroke length of the sliding member sliding relative to the outer sleeve.

12. The socket adapter device as claimed in claim 4, wherein the pushing portion is provided with a groove at one end close to the spring for accommodating the spring, and two opposite ends of the spring respectively abut against the bottom surface of the accommodating groove and a bottom surface of the groove of the pushing portion.

13. The socket adapter device as claimed in claim 7, wherein the pushing portion is provided with a groove at one end close to the spring for accommodating the spring, and two opposite ends of the spring respectively abut against the bottom surface of the accommodating groove and a bottom surface of the groove of the pushing portion.
